(19) United States
(12) Patent Application Publication
(10) Pub. No.: US 2026/0071783 A1
(43) Pub. Date: Mar. 12, 2026

(54) Integrated Modular Thermal Energy Collection, Storage, and Discharge Device including Thermal Battery Pack Recirculating Housing

(71) Applicant: Exowatt, Inc., Miami, FL (US)

(72) Inventors: Kiran Kambly, Miami, FL (US); Sushrut Bapat, Miami, FL (US); Pedro Neves, Miami, FL (US); Ehsan Ordouie, Miami, FL (US); Hannan Parvizian, Miami, FL (US); John M DeLappe, Miami, FL (US); Christopher Rengifo, Miami, FL (US); Simon Shuham, Miami, FL (US)

(21) Appl. No.: 19/323,959

(22) Filed: Sep. 9, 2025

Related U.S. Application Data
(60) Provisional application No. 63/692,688, filed on Sep. 9, 2024.
(60) Provisional application No. 63/692,684, filed on Sep. 9, 2024.

(51) Int. Cl. F24S 20/20; F24S 23/30; F24S 30/42; F24S 60/00

(52) U.S. Cl. CPC F24S 20/20; F24S 23/31; F24S 30/42; F24S 60/00

(57) ABSTRACT

A solar energy collection system comprising: a plurality of tracked Fresnel lens arrays; a corresponding plurality of thermal cells positioned to receive solar energy focused by the respective plurality of tracked Fresnel lens arrays; and a working fluid circulation system that circulates a working fluid through the plurality of thermal cells to a discharge point. The discharge point comprises a power conversion unit such as a thermal engine and generator. A thermal housing comprises a first trough-shaped portion that accepts at least one thermal storage device; a second trough-shaped portion providing an air channel for flow of air; a baffle that redirects flow of air through the second trough-shaped portion to the first trough-shaped portion; and a top plate including at least one aperture that enables communication of heat into the first trough-shaped portion.

### CROSS-REFERENCE TO RELATED APPLICATIONS

This application claims benefit of U.S. Provisional Ser. No. 63/692,688 filed Sep. 9, 2024 and U.S. Provisional Ser. No. 63/692,684 filed Sep. 9, 2024, each of which is incorporated herein by reference in their entirety and for all purposes. This application is related to the following copending applications each of which is incorporated herein by reference for all purposes:
“Thermal Battery Pack” (Attorney Docket No. 8839-27), application no. 63/692,681 filed Sep. 9, 2024;
“Solar Collection Platform” (Attorney Docket No. 8839-30), application no. 63/692,686 filed Sep. 9, 2024 and application Ser. No. 19/323,737 filed on date even herewith (“Solar Collection Platform”);
“Multi-Drive Fresnel Lens Trackers for Sequential Heat Collection” (Attorney Docket No. 8839-24), application no. 63/692,663 filed Sep. 9, 2024 and application Ser. No. 19/323,737 filed on date even herewith (Attorney Docket No. 8839-54) (collectively “Multi-Drive Fresnel Lens Trackers”);

### FIELD

The technology herein relates to thermal energy collection, and in particular to integrated thermal energy collection, storage and discharge, and to modular solar collection platforms. The technology herein also relates to thermal energy storage, and more particularly to a recirculation housing for insulating and thermally coupling thermal battery packs.

### BACKGROUND & SUMMARY

Thermal collection systems are often constructed of preexisting commercially available components such as solar collectors, thermal storage and thermal loads. Efficiencies can be gained by providing thermal energy collection, thermal storage and thermal discharge within the same overall integrated thermal system.

Unlike conventional battery packs that store energy in the form of electrochemically reactive compounds, “thermal batteries” (heat storage devices) store energy in the form of heat (radiant energy). As one example of a thermal storage, our ancestors commonly would heat stones in the hearth or fire and use the heated stones as bedwarmers. The modern era provides few practical large scale “thermal battery” solar collection heat storages that can directly capture and store large quantities of heat in structures that enable efficient drawout of heat for application to heat driven processes such as thermal engines without need for any intermediate heat exchangers and associated heat losses.

### BRIEF DESCRIPTION OF THE DRAWINGS

FIG. 1 is a block diagram of an example solar collection system.

FIG. 2 is a block diagram of an example battery pack.

FIG. 3 is a block diagram of an example battery cell.

FIG. 4 is a block diagram of an example PCU.

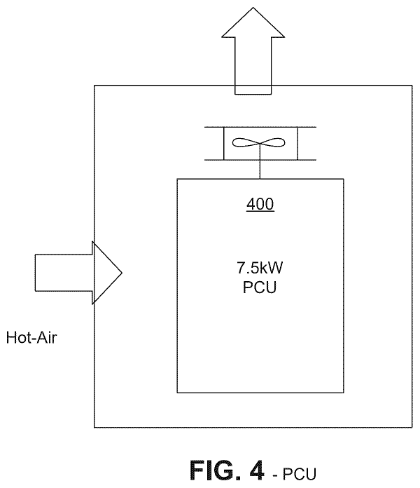

FIG. 5 is a cross-sectional view of a thermal battery pack having a recirculating housing.

FIG. 6 shows example air flow through the housing in a cross section of a battery pack with five cells and an insulation box, portraying separate inlet and outlet air channels.

FIG. 7 shows an exploded view of the battery pack housing internal cells.

FIG. 8 shows two stacked housings both feeding heat into a thermal engine.

FIG. 9 shows example ductwork details.

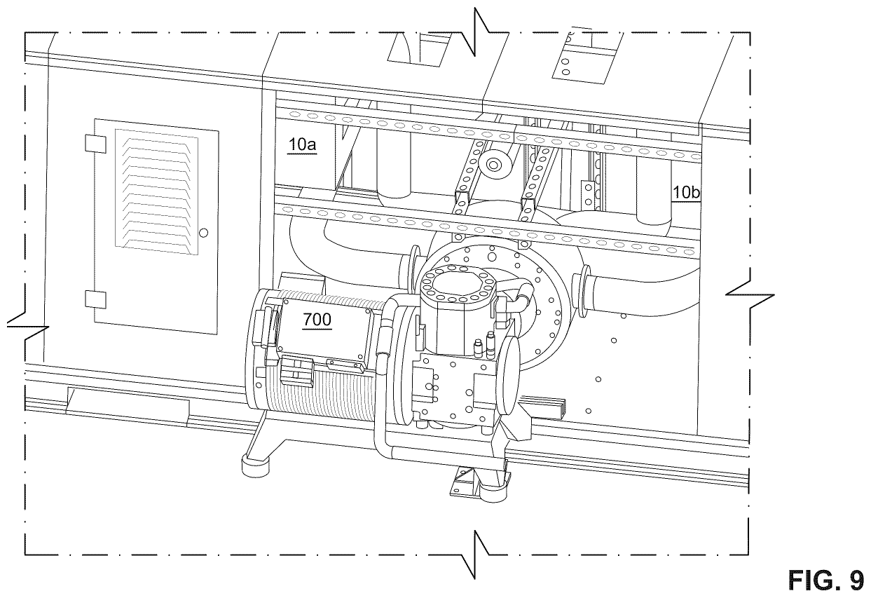

### DETAILED DESCRIPTION OF NON-LIMITING EMBODIMENTS

Example embodiments provide modularized thermal battery cells for a solar collection system for heat collection, storage and discharge, and reduced auxiliary loads, to directly capture heat in the storage medium without any need or requirement for an intermediate heat exchanger.

Example embodiments further provide a distributed thermal battery pack comprising multiple individual battery cells, each battery cell containing a heat collection, storage and discharge section. The heat collection system in one embodiment comprises a Fresnel lens setup that concentrates energy through apertures for each individual battery cell, towards a receiver surface defined in each such cell. The receiver surface may be formed directly on top of the storage to allow for direct heat storage without need for an additional heat exchanger.

In one embodiment, a thermal housing comprises an insulative housing including first trough-shaped portion that accepts at least one thermal storage device; a second trough-shaped portion providing an air channel for flow of air; a baffle that redirects flow of air through the second trough-shaped portion to the first trough-shaped portion; and a top plate including at least one aperture that enables communication of heat into the first trough-shaped portion. Such a thermal housing can be used to recirculate a working fluid such as air through the battery cells multiple times as the working fluid passes through the housing.

Heat storage is achieved by a sensible heat mechanism and can be a solid media, packed bed or a combination of both. The storage media contains a discharge zone where a finned heat exchanger is integrated to allow for convective discharge.

Also contained in the battery cell is a zone for grid charging. The battery pack combines multiple cells, houses ducts and manifolds, and a blower to deliver high-temperature hot-air.

A thermal battery pack comprises multiple battery cells, each containing a heat collection, storage and discharge section. The housing accommodates a longitudinal stack of such multiple battery cells. The heat collection in one embodiment comprises a Fresnel lens setup that concentrates energy through an aperture in the housing, towards a receiver surface. The receiver surface is placed directly on top of (in contact with) the storage to allow for direct heat storage. Heat storage is achieved by a sensible heat mechanism and can be a solid media, packed bed or a combination of both. The storage media contains a discharge zone where a finned heat exchanger is integrated to allow for convective discharge. Also contained in the battery cell is a zone for electrical power grid based charging. The battery pack combines multiple cells, houses ducts and manifolds, and a blower to deliver high-temperature hot-air.

One example embodiment provides a solar energy collection system comprising: a plurality of tracked Fresnel lens arrays; a corresponding plurality of thermal cells positioned to receive solar energy focused by the respective plurality of tracked Fresnel lens arrays; and a working fluid circulation system that circulates a working fluid through the plurality of thermal cells to a discharge point. The discharge point comprises a power conversion unit such as a thermal engine and generator, e.g., a Stirling engine.

The technology herein provides a heat insulative housing for such a heat storage device, which can circulate a working fluid (e.g., a gas such as air) therethrough in order to transfer heat to/from the thermal battery cells within the heat insulative housing. In one example embodiment, the insulative housing circulates the working fluid through the thermal battery twice before delivering the now-heated working fluid to the thermal load.

### Example Solar Collection System

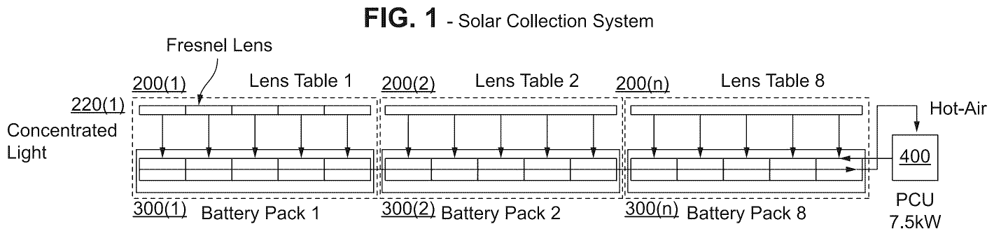

FIG. 1 shows a block diagram of an example embodiment integrated solar heat collection, heat storage and heat discharge providing a plurality of solar collection platforms (SCPs) 200. The SCPs 200 in one embodiment are sized as a standard intermodal containers of the type that can be loaded onto a train or pulled by a tractor (truck) portion of a tractor-trailer.

In the example shown, eight (8) such solar collection platforms (SCPs) 200 each comprising a single-axis multi-drive Fresnel lens array 220 carrying a certain number e.g., 5 Fresnel lenses, and a thermal battery pack 300 comprising thermal housing containing a corresponding number of thermal battery cells (one for each Fresnel lens) can be connected end to end to provide common hot air circulation through a power conversion unit (PCU) 400 such as a 7.5 KW Stirling engine with integral electrical generator. Eight is not limiting; any positive integer number of such modular SCPs can be so connected, for example, one, two, three, four, five, six, seven, eight, nine, or so on. In the example shown, each SCP 200 has its own thermal storage, which is distributed throughout the platform.

In more detail, FIG. 1 shows an overall solar collection system 10 comprising a number of solar collection “lens tables” 220 each optically coupled to a corresponding thermal battery 300. There may be any number of lens tables 220(1), 220(2), . . . 220(n) and corresponding thermal batteries 300(1), 300(2), 300(n), with a one-to-one correspondence between lens tables 220 and thermal batteries 300. Thus, lens table 220(1) focusses and directs energy to thermal battery 300(1), lens table 220(2) focusses and directs energy to thermal battery 300(2), and so on.

In one embodiment, modular SCP 200 comprises a linear array of one or more Fresnel lenses mounted to a tracking device such as a single axis tracker with additional north-south tracking capabilities, as described for example in “Solar Collection Platform”. Such a collection and tracking system is able to adapt automatically to the sun's changing position in the sky over time to ensure each Fresnel lens in a lens table 220 efficiently focusses energy radiated by the sun onto a corresponding absorber portion of a thermal battery pack 300. The system is modular and expandable such that a lens table 220 and corresponding battery pack 300 can be added or subtracted to increase or decrease, respectively, the solar collection capabilities of the overall system. In one example embodiment, each lens table 220 is physically supported by its corresponding battery pack 300 such that the lens table is mounted to the corresponding battery pack and is rotatable and otherwise moveable relative to the corresponding battery pack. In one embodiment, each battery pack 300 is equipped with actuators that move corresponding lens table 220 relative to the battery pack so the lens table tracks the sun's changing position. In such embodiment, the actuator(s) for a first battery pack 300(1)/lens table 220(1) combination operates independently from the actuator(s) for a second battery pack 300(2)/lens table 220(2) combination, the actuator(s) for the second battery pack 300(2)/lens table 220(2) combination operates independently from the actuator(s) for a third battery pack 300(3)/lens table 220(3) combination, and so on. In one embodiment, all of the actuators are controlled in synchronism so the various lens tables 220 move together to track the sun together and avoid physically interfering with one another (e.g., longitudinal motion along the common longitudinal axis of the lens tables 220 are performed by all of the lens tables at the same time so no lens table strikes or physically interferes with any neighboring lens table). In other embodiments, actuators can be shared between SCPs 200.

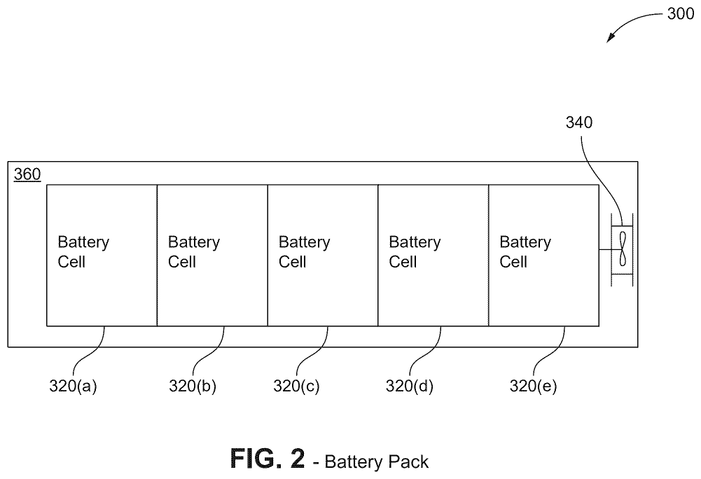

In the example shown, the battery packs 300 thermally communicate with one another, i.e., a blower system in one embodiment removes heat from the battery packs by blowing heated air successively through the array of battery packs to a thermal load such as a PCU 400. The heat circulation and transport system can be integrated so a continuous flow is provided through all SCPs 200 to the thermal load 400. As shown in FIG. 2, each battery pack 300 can be modular, and may include a bank of battery cells 320(a), 320(b), . . . and a blower 34 disposed within a housing 36. In one embodiment, a blower 340 in each modular housing 300 circulates air through the housing and across battery cells 320 within the housing to transport heat stored in the battery cells to thermal load 400 (first potentially passing through other modular housings of other modular SCPs).

### Example Battery Pack

FIG. 2 is a side perspective view of a heat insulative housing 10 for a collection of multiple modular heat battery cells of the type described in e.g., “Thermal Battery Pack”. In an example arrangement, a plurality of Fresnel lens frames or tables such as described in “Multi-Drive Fresnel Lens Trackers” collect solar energy from the sun and focus the collected energy through apertures defined in and through the upper surfaces of the battery pack housings to impinge on heat receivers of respective thermal cells described in “Thermal Battery Pack”. Each battery pack housing can comprise or contain a battery pack including a plurality of individual thermal cells. As shown in FIG. 2, any number of battery packs (each of which may be within its own respective housing, thus providing modularity) can be disposed end to end or otherwise “stacked” and coupled together such that a working fluid transport mechanism such as a gas or air blower can commonly circulate gas or air through a series of such battery packs. The battery packs together may progressively heat the working fluid to higher temperatures for discharging and delivering to a thermal load 400 such as a thermal or Stirling engine.

The modular design of battery cells within a given housing provides flexibility. For example, a smaller number of SCPs can be stacked together to provide a 12-hour solution to thermally power a given thermal load. A greater number of SCPs can be stacked together to provide a 24-hour solution to thermally power the same thermal load. Different SCPs can be used to thermally power different thermal loads. Example embodiments thus provide at least two or more levels of modularity providing flexible expansion and contraction of heat collection and storage capabilities:

In one embodiment, each SCP module comprises a Fresnel lens array and associated thermal housing providing integrated heat receivers/absorbers and directed coupled heat storage battery packs.

Each housing and associated battery pack may comprise a number of independent modular thermal battery cells that are coupled together to provide an overall battery pack.

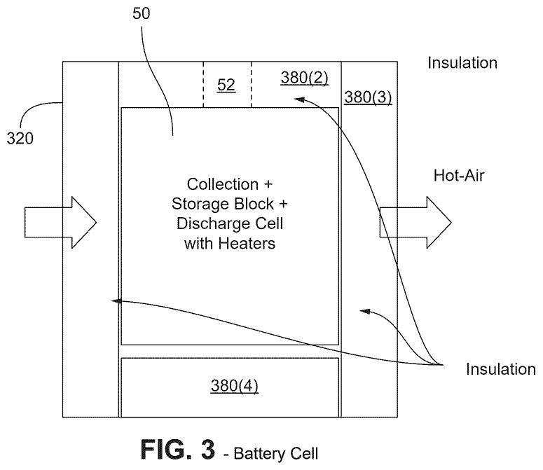

Each battery cell may comprise thermal retention material 50. FIG. 3 shows an example battery cell 320 comprising the thermal retention material 50 surrounded on all sides by thermally-insulative layers 380. See “Thermal Battery Pack”. A channel and/or window 52 through housing 36 allows solar energy focused by a Fresnel lens(es) as shown in FIG. 1 to penetrate through the insulative layers 58 to impinge directly onto the thermal retention material 50 within battery cell 320. This focused solar energy heats the thermal retention material 50, thereby thermally “charging” the battery cell 320. Additional thermal charging can be provided electrically by drawing electricity from the electrical grid and applying it to heat each battery cell individually.

A channel and/or window 52 disposed through the upper surface of each battery cell corresponding housing portion is sized and configured to enable a focal point that changes in size and/or position with Fresnel lens movement/rotation and changing sun position to reach the internal thermal retention material 50. For example, in one embodiment, the channel and/or window 52 may be a slot with a particular length that accommodates lens focal positions that change in position as the sun seasonably and/or daily changes its position in the sky. In one embodiment, the housing provides a corresponding slot for each battery cell 320, which is optically coupled to a corresponding rectangular Fresnel lens panel. Thus, a housing may have 5 slots 52 corresponding to 5 different internal battery cells 320 that receive energy from 5 different respective corresponding Fresnel lens panels in a tracked 5-panel lens array. In such an embodiment, as shown in FIG. 1, a first Fresnel lens panel 220 focuses solar energy through a first housing slot 52 onto a first battery cell 320, a second Fresnel lens panel 220 focuses solar energy through a second housing slot 52 onto a second battery cell 320, a third Fresnel lens panel 220 focuses solar energy through a third housing slot 52 onto a third battery cell 320, a fourth Fresnel lens panel 220 focuses solar energy through a fourth housing slot 52 onto a fourth battery cell 320, a fifth Fresnel lens panel 220 focuses solar energy through a fifth housing slot 52 onto a fifth battery cell 320, and so on. In other embodiments, the housing slot 52 can be shared by multiple lens panels and multiple battery cells (for example, a housing slot can be or comprise a continuous linear opening across the top surface of the housing that spans some or all battery cells within the housing) so that light from each Fresnel lens can pass through the common slot to a corresponding battery cell.

### Example Housing Configuration

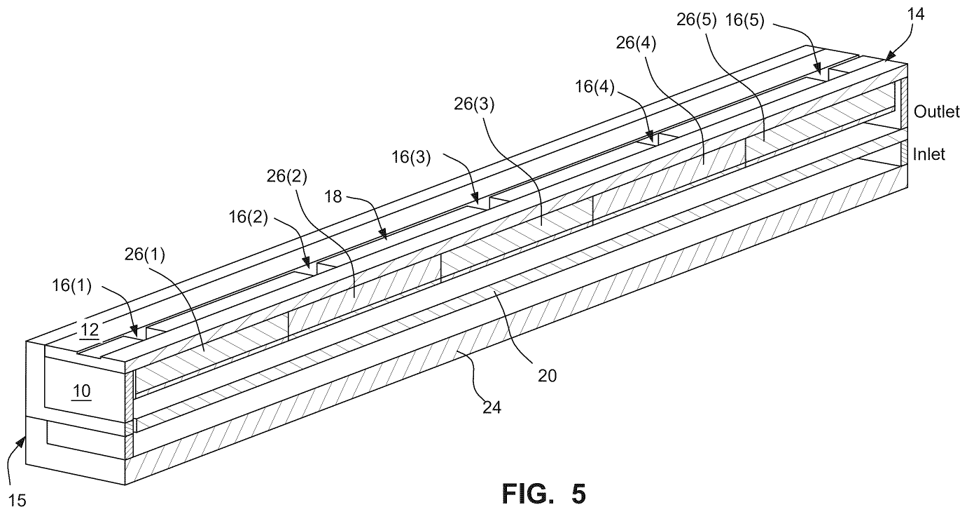

FIG. 5 shows an example configuration for a housing 10. Housing 10 in the embodiment shown is rectangular in shape with planar parallel top, side and bottom surfaces, but other shapes are possible. In the example shown, the length of housing 10 is substantially longer than either the height or the width of the housing, and the height and width of the housing are approximately the same, but other dimensions are possible.

In this embodiment, the housing 10 provides space therewithin to contain and house a number (in this case five) thermal battery packs 26(1), 26(2), 26(3), 26(4), 26(5) (these can be the same thermal battery packs 300 described above). In the example shown, these battery packs 26 are disposed end-to-end with the housing 10 so that the battery packs collectively extend over substantially the entire length of the housing. The housing 10 is insulated such that it retains heat within the battery packs 26 and does not allow it to readily escape into the environment. The housing 10 has circulation channels that circulate a working fluid such as air to pick up heat from the battery packs 26 and convey that head to a thermal load such as PCU/Stirling engine. In one example, the inlet air flow through the housing is channeled to flow into an internal channel defined within the endmost battery cell 26(1). The inlet flow in turn flows through battery cell 26(2), battery cell 26(3), battery cell 26(4) and battery cell 26(5) before encountering a baffle 14 at the end of the housing that causes the air to flow back in reverse through outlet channels defined within battery cell 26(5), battery cell 26(4), battery cell 26(3), battery cell 26(2), and battery cell 26(1). Upon exiting battery cell 26(1), the air is channeled into the outlet air flow within the housing 10 to exit the housing. In this way, air can circulate from one end of the housing to the other in a first direction, then flow through all of the internal battery cells 26 in a second direction opposite the first direction, then flow through all of the internal battery cells again in the first direction, and then flow back through the housing in the second direction, substantially without the inlet and outlet air mixing. The circulating air thus travels the length of the housing four times and passes through each battery cell 26 twice, picking up thermal energy from the battery cells and conveying the thermal energy to a thermal load external to the housing 10.

In example embodiments, the battery cells 26 have dual passages therein so that one part or half of the battery cell communicates with a first internal passage and a second part or half of the battery cell communicates with a second internal passage. The passages can be parallel to one another and co-directional with one another, but in one embodiment do not communicate with one another. Thus, air can flow independently through each of the two passages. In one embodiment, air flows through the first passage in a first direction, and air flows through the second passage in a second, different direction (e.g., opposite the first direction). But in other embodiments, air could flow through the same direction in each of first and second passages.

The housing 10 also defines openings 16 in a top surface thereof to allow lenses disposed above the housing to focus radiant energy onto a top heat receiving surface (e.g., an optical grating in one embodiment) of the internal battery packs 26 without allowing much heat to escape from the internal battery packs.

In more detail, in this embodiment the housing's rectangular top surface 12 defines, along a longitudinal axis thereof, a series of apertures 16 (square or rectangular openings) spaced along the top surface. The apertures 16 are defined through top surface 12. In this embodiment, the apertures 16 are square but they could be circular or have other shapes. The apertures 16 allow focused heat energy (e.g., as collected and focused by respective Fresnel lenses) to penetrate through the top surface 12 into the interior of housing 10 to reach the battery packs 26. In the embodiment shown, there is a one-to-one correspondence between apertures 16 and battery packs 26—that is, aperture 16(1) provides a radiant energy pathway to internal battery pack 26(1), aperture 16(2) provides a radiant energy pathway to internal battery pack 26(2), and so on.

The housing top surface 12 is made of high temperature heat insulative material that will not degrade under high temperatures and will also insulate to cause heat to remain within an interior space(s) within the housing. It has a thickness that will provide a desired heat insulation factor. As shown in exploded FIG. 3, top surface 12 is defined by a flat grooved plate having the apertures 16 therethrough. In one embodiment, a longitudinal groove runs down the center of the top surface 12 along the length of the top surface, and the apertures 16 are defined within the groove. In one embodiment, the apertures 16 can be shutterable to close the apertures (e.g., by sliding a further insulative plate not shown into groove 18) when no heat from external sources is focused on the apertures (e.g., overnight) in order to further prevent heat from escaping the housing 10—although shutters are not necessary for operation and need not be installed.

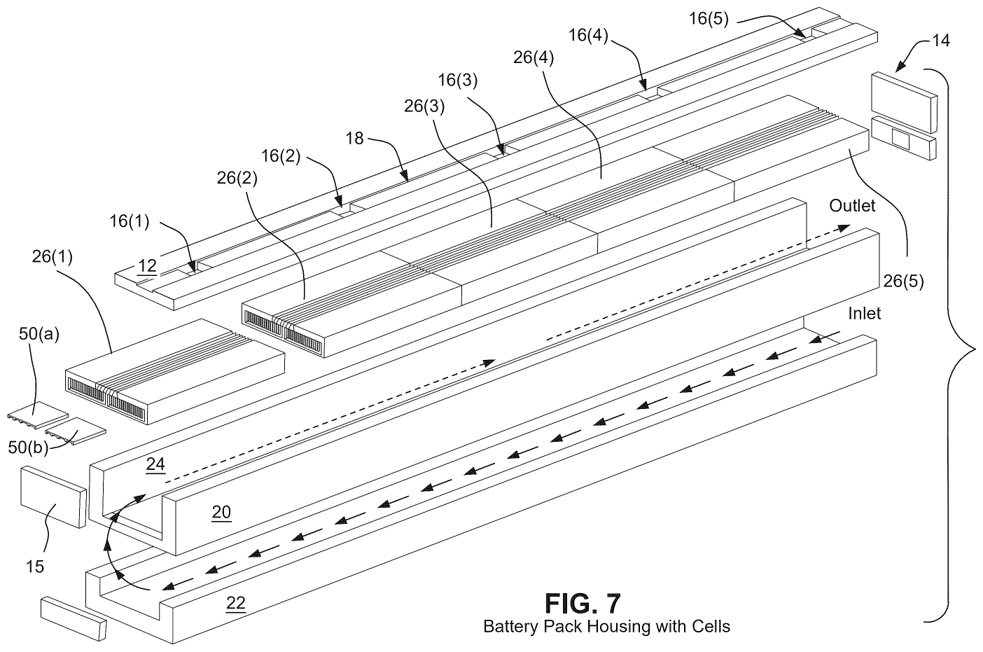

Housing 10 further comprises a two-piece channeled lower portion best seen in the FIG. 7 exploded view, comprising a center trough-shaped plate 20 and a lower trough-shaped plate 22. The center trough-shaped plate 20 has a deep longitudinal channel 24 dimensioned to accept and accommodate thermal storage battery cells 26 and position the storage cells in registration with the apertures 16. For example, cell 26(1) is positioned in registry with aperture 16(1), cell 26(2) is positioned in registry with aperture 16(2), and so on. Heat passing through apertures 16 directly impinge on respective heat storage cells 26. In some example embodiments, the cells 26 are themselves channeled to allow air to circulate and flow through the heat storage cells, thereby transporting heat from cell to cell and from the cells to a heat load such as a thermal engine. In other example embodiments, the heat storage cells 26 release heat as air flows past them through an air flow channel (best seen in FIG. 2) defined by the center trough-shaped plate. The center trough-shaped plate 20 enables and supports such air flow, as shown in FIG. 2. For more details concerning example heat storage cells 26, see the above-cited copending commonly-assigned patent applications.

Also as shown in FIG. 7, each heat storage cell 26 may accept one or a plurality of resistive electrical heating elements 50a, 50b. These resistive electrical heating elements 50 may produce heat when electricity is applied to them. This capability allows the system to continue to function and provide heat output under low light conditions such as between sunset and sunrise. In one embodiment, the heating elements 50 are planar, made of ceramic or other suitable material, and may be insertable into and removable from the battery cells 26. Thus, each battery cell 26 shown may include a set of heating elements. When electrical current is applied to the heating elements 50, the heating elements generate radiant energy (heat) that heats up the material comprising the battery cells 26. This can keep the battery cells 26 at above a given temperature even when no light or radiant energy is incoming through the apertures 16.

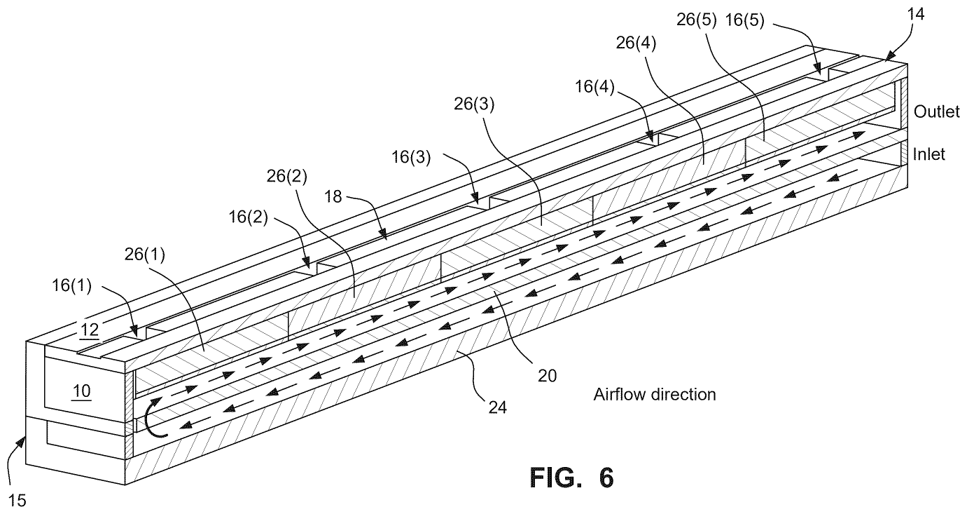

As shown in FIG. 6, housing 10 provides circulation of air flow from a cooler air inlet (not shown) at end 14 along the length of the housing through the lower trough 24 to end 15, then upward into the upper trough 20 and back along the length of the housing to a hot air outlet (not shown) at end 14. In example embodiments, end plate 15 acts as a reversing baffle that reverses the flow of air from lower trough 24 and channels it into upper trough 20 for reverse flow past and/or through the thermal battery cells 26 to a hot air outlet. The hot air outlet can feed a thermal load such as a Stirling engine that converts heat to electricity.

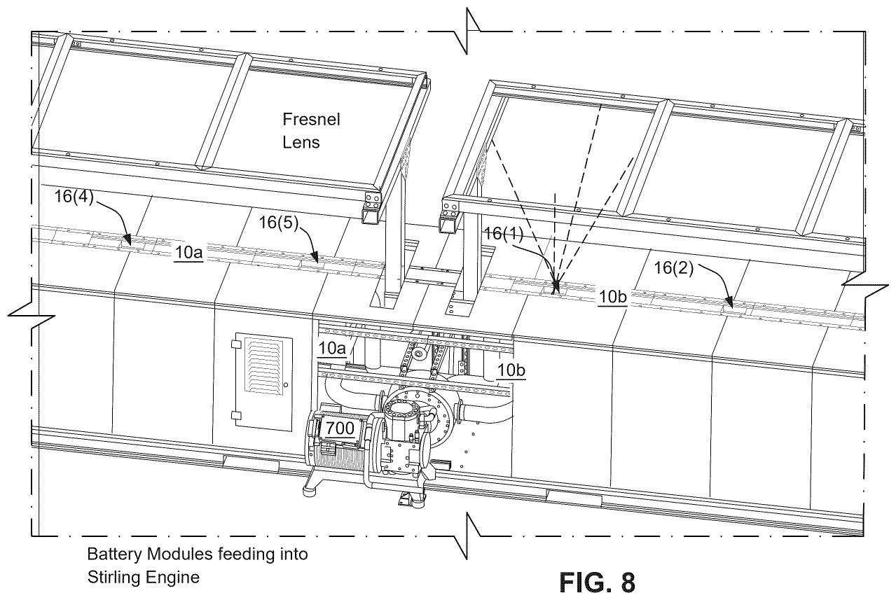

FIG. 8 shows how two (or more) housings 10 can be “stacked” end to end to each provide heated airflow to a thermal load such as a Stirling engine 700 through ductwork and blowers that circulate air flow through the housings. In the FIG. 8 example shown, a first airflow flows through a first housing 10a (to the left and back to the right) and a second airflow flows through a second housing 10a (to the right and back to the left)—each of the first housing and second housing positioned to receive thermal energy focused on their apertures 16 from respective Fresnel lens panels disposed in frames suspended above the housing 10. Ductwork shown in more detail in FIG. 5 connects to respective hot air outlets and cooler air inlets of the housings 10 as described above, Thus, multiple housings 10 and associated internal battery cell storages 26 contribute to heat supplied to the thermal load. The Fresnel lenses can be moved in one or two axes to track the sun's position in the sky.

### EXAMPLE

A solar energy collection system comprising: a tracked Fresnel lens array comprising a plurality of Fresnel lenses; and a corresponding plurality of thermal storage devices positioned to receive solar energy focused by the respective plurality of Fresnel lens, wherein the plurality of thermal storage devices each comprise a thermal cell disposed within an insulated housing defining at least one window or opening through which energy focused by a Fresnel lens can penetrate to heat the thermal cell.

A working fluid circulation system circulates a working fluid through the plurality of thermal storage devices to a discharge point comprising a power conversion unit.

The insulated housing has a form factor of an intermodal container.

The tracked Fresnel lens array comprises a linear array of rectangular Fresnel lens panels mounted above the housing on a single-axis mechanical tracker device.

The insulated housing defines a plurality of windows or openings in one-to-one correspondence with a corresponding plurality of thermal battery cells and a corresponding plurality of Fresnel lenses, each window or opening passing focused light from a corresponding Fresnel lens to a corresponding thermal battery cell.

The insulated housing defines at least one window or opening that passes focused light from a Fresnel lens to a corresponding thermal battery cell.

A single axis tracking device that automatically moves the array to track the sun's position.

The array comprises a linear array of rectangular Fresnel lens panels mounted in a frame.

The linear array is tracked for elevation and north-south orientation.

The solar energy collection system is modular.

A solar energy collection method comprises tracking the sun's position with a Fresnel lens array comprising a plurality of Fresnel lenses; and receiving, with a corresponding plurality of thermal storage devices, solar energy focused by the respective plurality of Fresnel lens, wherein receiving includes passing focused solar energy to thermal cells disposed within an insulated housing defining at least one window or opening through which energy focused by a Fresnel lens penetrates to heat the respective thermal cell.

A working fluid circulates through the plurality of thermal storage devices to a discharge point comprising a power conversion unit.

The insulated housing has a form factor of an intermodal container.

Single-axis tracking comprises tracking a linear array of rectangular Fresnel lens panels mounted above the housing.

The insulated housing defines a plurality of windows or openings in one-to-one correspondence with a corresponding plurality of thermal battery cells and a corresponding plurality of Fresnel lenses, and the method further includes passing focused light from a corresponding Fresnel lens through each window or opening to a corresponding thermal battery cell.

The method further includes passing focused light from a Fresnel lens through at least one window or opening defined through an insulated housing to a corresponding thermal battery cell.

The array is moved automatically in a single axis to track the sun's position.

The array comprises a linear array of rectangular Fresnel lens panels mounted in a frame.

The linear array is tracked for elevation and north-south orientation.

The solar energy collection method is modular.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A thermal housing comprising:
a first trough-shaped portion that accepts at least one thermal storage device;
a second trough-shaped portion providing an air channel for flow of air;
a baffle that redirects flow of air through the second trough-shaped portion to the first trough-shaped portion; and
a top plate including at least one aperture that enables communication of heat into the first trough-shaped portion.

2. A thermal storage device comprising:
an insulative housing defining a working fluid inlet and a working fluid outlet, and
a plurality of modular storage cells disposed within the insulative housing,
wherein the insulative housing defines a working fluid circulating path within the insulative housing between the working fluid inlet and the working fluid outlet that passes working fluid through each of the plurality of modular storage cells plural times as the working fluid flows from the working fluid inlet to the working fluid outlet.

3. The thermal storage device of claim 2 wherein the insulative housing further comprises an upper surface having apertures defined therein, there being a one-to-one correspondence between apertures and the plurality of modular storage cells disposed within the insulative housing.

4. A method comprising:
flowing a working fluid through an inlet into a insulative housing containing a plurality of thermal cells;
flowing the working fluid from the inlet through all of the plurality of thermal cells in a first direction;
flowing the working fluid that has passed through all of the plurality of thermal cells back through the plurality of thermal cells in a second direction opposite the first direction; and
outputting the working fluid that has flowed in the second direction.

5. The method of claim 4 further including passing the working fluid to be outputted in a direction back toward an inlet end of the insulative housing.

6. A solar energy collection system comprising: a tracked Fresnel lens array comprising a plurality of Fresnel lenses; and a corresponding plurality of thermal storage devices positioned to receive solar energy focused by the respective plurality of Fresnel lens, wherein the plurality of thermal storage devices each comprise a thermal cell disposed within an insulated housing defining at least one window or opening through which energy focused by a Fresnel lens can penetrate to heat the thermal cell,
wherein the system has plural levels of modularity, a first modularity level comprising the configuration of multiple Fresnel lens arrays and associated thermal storage devices, the second level of modularlity comprising the configuration of multiple Fresnel lenses in each array and associated thermal storage devices per Fresnel lens array.

7. The system of claim 6 wherein a working fluid circulation system circulates a working fluid through the plurality of thermal storage devices to a discharge point comprising a power conversion unit.

8. The system of claim 6 wherein the insulated housing has a form factor of an intermodal container.

9. The system of claim 6 wherein the tracked Fresnel lens array comprises a linear array of rectangular Fresnel lens panels mounted above the housing on a single-axis mechanical tracker device.

10. The system of claim 6 wherein the insulated housing defines a plurality of windows or openings in one-to-one correspondence with a corresponding plurality of thermal battery cells and a corresponding plurality of Fresnel lenses, each window or opening passing focused light from a corresponding Fresnel lens to a corresponding thermal battery cell.

11. The system of claim 6 wherein the insulated housing defines at least one window or opening that passes focused light from a Fresnel lens to a corresponding thermal battery cell.

12. The system of claim 6 further including a single axis tracking device that automatically moves the array to track the sun's position.

13. The system of claim 6 wherein each array comprises a linear array of rectangular Fresnel lens panels mounted in a frame.

14. The system of claim 6 wherein each linear array is tracked for elevation and north-south orientation.

15. A solar energy collection method comprises tracking the sun's position with a Fresnel lens array comprising a plurality of Fresnel lenses; and receiving, with a corresponding plurality of thermal storage devices, solar energy focused by the respective plurality of Fresnel lens, wherein receiving includes passing focused solar energy to thermal cells disposed within an insulated housing defining at least one window or opening through which energy focused by a Fresnel lens penetrates to heat the respective thermal cell and further including passing a working fluid through the plurality of thermal storage devices first in a first direction then in a second direction.
